(19) United States
(12) Patent Application Publication
(10) Pub. No.: US 2024/0384579 A1
(43) Pub. Date: Nov. 21, 2024

(54) Portable Safety Door Stopper and Room Door Blocking Method

(71) Applicant: Ying WANG, Zhejiang (CN)

(72) Inventor: Ying WANG, Zhejiang (CN)

(21) Appl. No.: 18/741,749

(22) Filed: Jun. 12, 2024

(30) Foreign Application Priority Data
May 15, 2023 (CN) 202321164442.0

(51) Int. Cl. E05C 19/00; E05C 17/54

(52) U.S. Cl. CPC E05C 19/004; E05C 17/54

(57) ABSTRACT

The present invention relates to a portable safety door stopper and a room door blocking method. The portable safety door stopper comprises a stopper for attaching to the inner side of a door, a base laid flatwise on the ground, and a supporting post rotatably connected between the stopper and the base, wherein a locking hook component is built in the stopper, and the stopper can always cling to a set position on the inner side of the door through the locking action of the locking hook component, so that the installation of the safety door stopper is realized; an alarm module can be built in the base to achieve an alarm reminding function at the same time.

### CROSS-REFERENCE TO RELATED APPLICATIONS

This application claims the priority of China Patent Application No. 202321164442.0 filed on May 15, 2023, which is entitled “Portable Safety Door Stopper”, the entire contents of which, including the amendments therein, are all incorporated herein by reference.

### TECHNICAL FIELD

The present invention relates to the technical field of security and theft prevention, in particular to a portable safety door stopper and a room door blocking method.

### BACKGROUND

Whether at home or going out, the safety of the door is very important. There are many anti-theft safety countermeasures for the door in the market, but the most common combination of bolt and chain belt is not a very reliable way. Therefore, a kind of door resistance is needed to improve the residential safety. The door resistance can be used to prevent the door from being opened from the outside and fixed indoors. It is a device to ensure the safety of indoor personnel, and has the characteristics of stable structure and good support.

In the prior art, a door stopper is also provided to improve the residential safety, and it can be fixed indoors, such as U.S. Pat. No. 8,186,011B2, which has the characteristics of stable structure, good support and the like.

However, the door stopper disclosed above has the function of preventing the door from being opened from the outside. In practical process, for example, when traveling outside, the door stopper cannot be carried around and used everywhere, and cannot be used when traveling outside. In the prior art, many solutions have been proposed to improve the door stopper to be portable, for example, in the U.S. patent with a publication number of US20220034131A1 and the U.S. patent with a publication number of U.S. Pat. No. 7,030,758B1, however, the technical solutions disclosed above are supported on the door handle in the actual use process, which is cumbersome to use; and at the same time, based on the working principle, its structure needs a large space when it is used or stored, which reduces portability to a certain extent, is not convenient to adjust, and the locking effect needs to be improved.

Although many portable door resistances have been put forward in the prior art, users always hope to provide updated door resistances, which can improve the living safety while being able to be carried and ready to use.

Based on the above problems, it is necessary to put forward a brand-new portable safety door stopper, which has a good protective blocking function and can prevent the door from being opened from the outside. At the same time, when the user goes out, the door stopper can be conveniently and quickly folded, stored, installed and used. In addition, the door stopper also has an adjustment function, which is suitable for all types of doors and has a good versatility. At the same time, the door stopper has a simple structure and a low failure rate, which further improves the protective safety and use experience when using.

### SUMMARY

The present invention provides a portable safety door stopper, which includes a stopper for attaching to an inner side of a door, a base laid flatwise on the ground, and a supporting post rotatably connected between the stopper and the base, wherein a locking hook component is built in the stopper, and the stopper can always cling to a set position on the inner side of the door through a locking action of the locking hook component, so that the installation of the safety door stopper is realized.

The present invention further provides a portable safety door stopper, which includes a stopper for attaching to an inner side of a door, a base laid flatwise on the ground, and a supporting post rotatably connected between the stopper and the base to swing in a limited range, wherein the stopper is internally provided with a retractable insert part inserted into a gap at the bottom of the door, and an adjusting part for adjusting an extension length of the insert part is arranged in the stopper.

The present invention further provides a room door blocking method, including
providing an apparatus, which includes a stopper for attaching to an inner side of a door, a base laid flatwise on the ground, and a supporting post rotatably connected between the stopper and the base, wherein a locking hook component is built in the stopper, and the stopper can always cling to a set position on the inner side of the door through a locking action of the locking hook component, so that the installation of the safety door stopper is realized;
the method includes the following steps:
placing the base on the ground behind the door according to a scene;
rotating the supporting post to attach the stopper to the back of the door, and the locking hook component extending into the gap between the door and the ground; and
adjusting the locking hook component so that the stopper can always cling to the set position on the inner side of the door through a locking action.

### BRIEF DESCRIPTION OF DRAWINGS

In order to explain the technical solution of this application more clearly, the drawings needed in the implementation will be briefly introduced below. Obviously, the drawings described below are only some implementations of this application. For those skilled in the art, other drawings can be obtained according to these drawings without creative work.

FIG. 1 is a perspective view of a portable safety door stopper;

FIG. 2 is a schematic diagram of the internal structure of a portable safety door stopper;

FIG. 3 is a schematic structural diagram of a movable locking hook of a portable safety door stopper;

FIG. 4 is a schematic structural diagram of a supporting post of a portable safety door stopper;

FIG. 5 is a schematic diagram of the installation relationship of the bottom mat base of a portable safety door stopper;

FIG. 6 is a schematic diagram of the bottom mat pattern of a portable safety door stopper;

FIG. 7 is another schematic diagram of the bottom mat pattern of a portable safety door stopper;

FIG. 8 is another schematic diagram of the bottom mat pattern of a portable safety door stopper.

In the figures:

1) Bottom mat; 2) Base; 3) Supporting post; 31) Ball head; 311) Cutting part; 4) Stopper; 5) Adjusting screw; 6) Shaft clamp; 7) Riveting nut; 8) Movable locking hook; 81) First folded edge; 82) Second folded edge.

### DESCRIPTION OF EMBODIMENTS

In the following, the technical solution in the embodiment of the application will be clearly and completely described with reference to the drawings in the embodiment of the application. Obviously, the described embodiment is only a part of the embodiment of the application, but not the whole embodiment. Based on the embodiments in this application, all other embodiments obtained by those skilled in the art without creative labor belong to the protection scope of this application.

Reference to “an example” or “an embodiment” herein means that a particular feature, structure or characteristic described in connection with an embodiment or an embodiment can be included in at least one embodiment of this application. The appearance of this phrase in various places in the specification does not necessarily refer to the same embodiment, nor is it an independent or alternative embodiment mutually exclusive with other embodiments. It is understood explicitly and implicitly by those skilled in the art that the embodiments described herein can be combined with other embodiments.

In this specification, for the sake of convenience, words and expressions indicating orientation or positional relationship such as “middle”, “upper”, “lower”, “front”, “rear”, “vertical”, “horizontal”, “top”, “inner” and “outer” are used to illustrate the positional relationship of constituent elements with reference to the attached drawings, only for the convenience of description. The positional relationship of the constituent elements is appropriately changed according to the direction of the described constituent elements. Therefore, it is not limited to the words and expressions described in the specification, and can be replaced appropriately according to the situation.

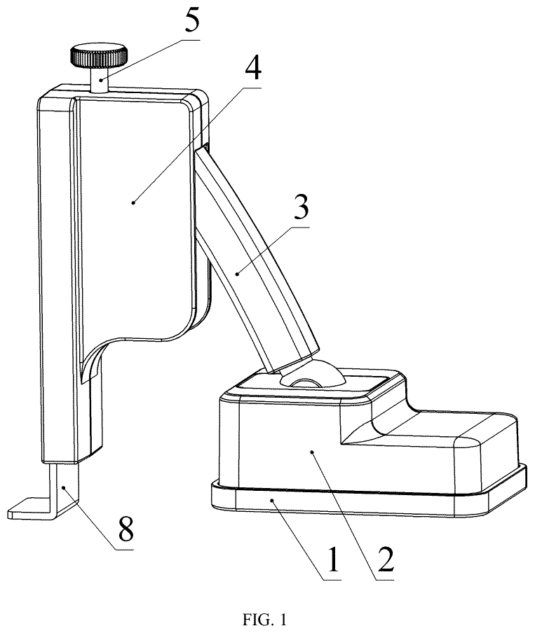

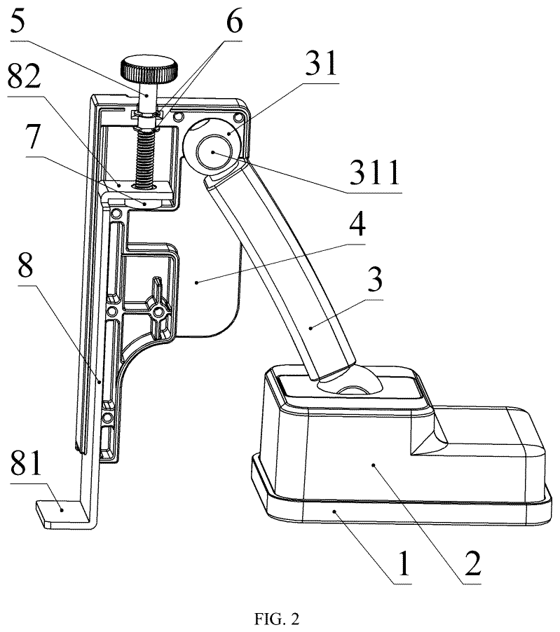

As shown in FIG. 1 and FIG. 2, the present invention provides a portable safety door stopper, which includes a stopper 4 for attaching to the inner side of the door, a base 2 laid flatwise on the ground, and a supporting post 3 rotatably connected between the stopper 4 and the base 2. The stopper 4 is internally provided with a locking hook component, and the stopper 4 can always cling to a set position on the inner side of the door through locking action, so as to realize the installation of the safety door stopper; the base 2 is rotatably connected with the stopper 4; when in use, the angle between the stopper 4 and the base 2 can be adjusted according to the size of the doorway space, allowing the base 2 to be adjusted to the uneven floor surface, and still safely supporting the stopper 4 in use.

As shown in FIG. 2, the stopper 4 is formed by fixedly connecting two half shells through screws. The locking hook component includes a movable locking hook 8 built in the stopper 4 and an adjusting screw 5 for driving the movable locking hook 8 to slide. The outer end of the movable locking hook 8 is bent to form a first folded edge 81, and the inner end of the movable locking hook 8 is in transmission connection with the adjusting screw 5. The movable locking hook 8 slides in the stopper 4 through the adjusting screw 5, and its height position is adjusted according to the space under the door to clamp the door bottom, which does not affect the adjustment. In this embodiment, the height position of the movable locking hook 8 is adjusted by the screw transmission of the adjusting screw 5, which has good self-locking performance. In some embodiments (not shown in the figure), a worm gear mechanism or a cam jack-up mechanism can also be used to realize self-locking protection after adjusting the height position of the movable locking hook 8.

In this embodiment, the outer end of the movable locking hook 8 forms an L-shaped block through the first folded edge 81 formed by bending. In order to further improve the clamping of the stopper 4 and the first folded edge 81 to the door, the top of the first folded edge 81 and the side surface of the stopper 4 are knurled to increase the friction. However, in some embodiments (not shown in the figure), the top of the first folded edge 81 and the side of the stopper 4 can be provided with anti-slip patterns or anti-slip bumps to further increase the friction force, and an elastic mechanism such as a coil spring is directly provided on the first folded edge 81 and the stopper 4, so that the first folded edge 81 keeps a state of tendency toward the stopper 4 to form an effect of clamping the door bottom, or a screw hole can be directly formed on the movable locking hook 8, and butted and installed under the door by mounting bolts.

As shown in FIG. 3, the inner end of the movable locking hook 8 is bent to form a second folded edge 82. A through hole is processed on the second folded edge 82, and a riveting nut 7 is arranged at the position of the through hole. The adjusting screw 5 is screwed with the riveting nut 7, and two shaft clamps 6 are arranged on the adjusting screw 5 to limit its axial movement. A compression spring is sleeved on the adjusting screw 5, and the compression spring is elastically supported between the second folded edge 82 and the inner wall of the stopper 4, so as to play a role in preventing looseness.

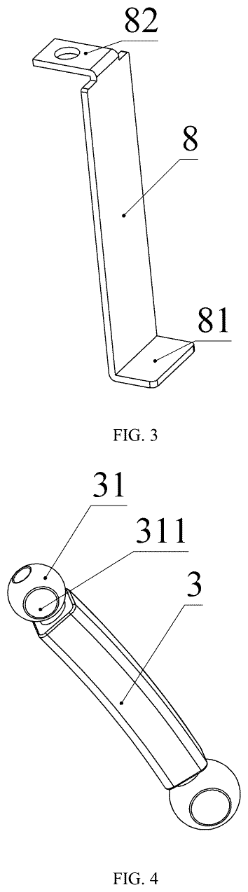

As shown in FIG. 4, both ends of the supporting post 3 are ball heads 31, and both sides of each of the ball heads 31 are provided with flat cutting parts 311. Both the base 2 and the stopper 4 are provided with cavities matched with the ball heads 31 after cutting. In this way, the supporting post 3 only rotates in one plane, and the stopper, the supporting post and the base can rotate like movable joints, without setting rotating parts such as rotating shafts and bearings, which simplifies the structure and keeps the triangular support structure in one plane, which is very stable.

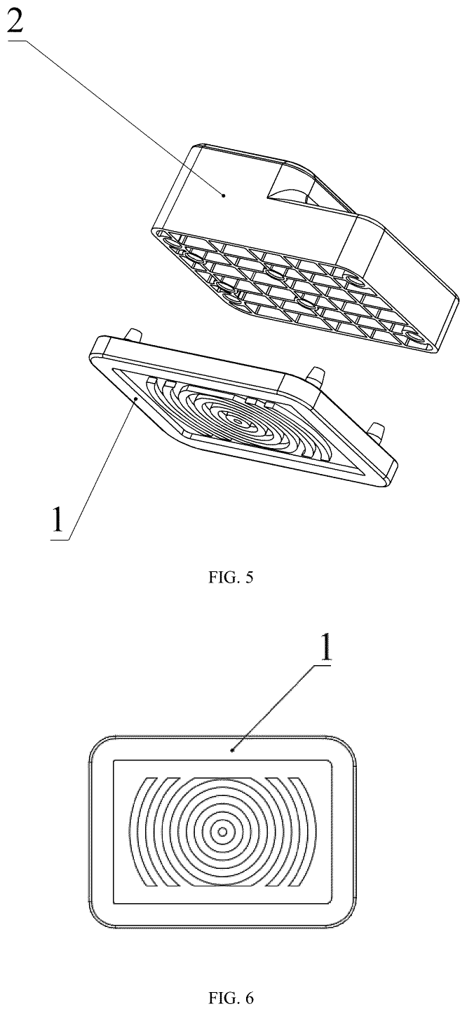

As shown in FIG. 5, the bottom of the base 2 is provided with an anti-skid bottom mat 1 to increase the friction with the ground, and the top of the anti-skid bottom mat 1 is installed under the base 2 by bolts or plugs to allow different types of anti-skid bottom mats 1 to be easily replaced. Besides, the detachable connection can also be applied to easily replace the anti-skid bottom mat 1.

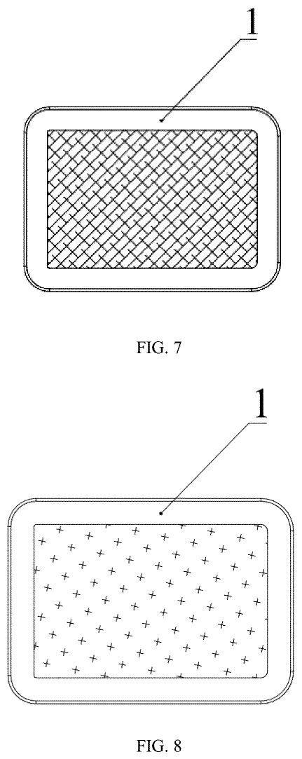

It is important to install different types of anti-skid bottom mats 1 under the base 2, so that the anti-skid bottom mats 1 will not fall off when in use. The anti-skid bottom mats 1 can be used for different floor surfaces with different patterns or different materials (such as rubber or neoprene elastomer) to provide additional resistance to the force applied to the stopper 4. There are many different types of floor surfaces mentioned above, including carpet, tile, stone, wood or cement. Four different door mats are shown in FIG. 6-8.

An alarm module is built in the base 2, so that the portable safety door has the function of alarm and reminder; The alarm module can be realized by means of pressure-sensitive trigger, and its selection can be realized by various existing alarm modules with pressure-sensitive trigger in the market. The control circuit of this kind of alarm module can control the buzzer to give an alarm sound, so as to warn people in the room to respond to the alarm or ask for help as soon as possible, thus effectively protecting the safety of life and property. This kind of alarm module has been applied in the technology that requires door resistance.

In another embodiment, the present invention provides another portable safety door stopper, which includes a stopper (4) for attaching to the inner side of the door, a base (2) laid flatwise on the ground, and a supporting post (3) rotatably connected between the stopper (4) and the base (2) to swing in a limited range, and the stopper (4) is internally provided with a retractable insert part inserted into a gap at the bottom of the door.

In this embodiment, as shown in FIG. 2, the stopper (4) is formed by fixedly connecting two half-shells through screws, the insert part includes a movable locking hook (8) built in the stopper (4), and the adjusting part includes an adjusting screw (5) for driving the movable locking hook (8) to slide; the outer end of the movable locking hook (8) is bent to form a first folded edge (81), and the inner end of the movable locking hook (8) is in transmission connection with the adjusting screw (5).

In this embodiment, as shown in FIGS. 2 and 3, the inner end of the movable locking hook (8) is bent to form a second folded edge (82), a through hole is processed on the second folded edge (82) and a riveting nut (7) is arranged at the position of the through hole; the adjusting screw (5) is in threaded connection with the riveting nut (7), and the adjusting screw (5) is provided with two shaft clamps (6) to limit its axial movement; a compression spring is sleeved on the adjusting screw (5), and the compression spring is elastically supported between the second folded edge (82) and the inner wall of the stopper (4). In some embodiments (not shown in the figure), the top of the first folded edge (81) and the side of the stopper (4) are both knurled.

As shown in FIG. 4, both ends of the supporting post 3 are ball heads 31, and both sides of each of the ball heads 31 are provided with flat cutting parts 311. Both the base 2 and the stopper 4 are provided with cavities matched with the ball heads 31 after cutting. In this way, the supporting post 3 only rotates in one plane, and the stopper, the supporting post and the base can rotate like movable joints, without setting rotating parts such as rotating shafts and bearings, which simplifies the structure and keeps the triangular support structure in one plane, which is very stable.

As shown in FIG. 5, the bottom of the base 2 is provided with an anti-skid bottom mat 1 to increase the friction with the ground, and the top of the anti-skid bottom mat 1 is installed under the base 2 by bolts or plugs to allow different types of anti-skid bottom mats 1 to be easily replaced. Besides, the detachable connection can also be applied to easily replace the anti-skid bottom mat 1.

It is important to install different types of anti-skid bottom mats 1 under the base 2, so that the anti-skid bottom mats 1 will not fall off when in use. The anti-skid bottom mats 1 can be used for different floor surfaces with different patterns or different materials (such as rubber or neoprene elastomer) to provide additional resistance to the force applied to the stopper 4. There are many different types of floor surfaces mentioned above, including carpet, tile, stone, wood or cement. Four different door mats are shown in FIG. 6-8.

An alarm module is built in the base 2, so that the portable safety door has the function of alarm and reminder; the alarm module can be realized by means of pressure-sensitive trigger, and its selection can be realized by various existing alarm modules with pressure-sensitive trigger in the market. The control circuit of this kind of alarm module can control the buzzer to give an alarm sound, so as to warn people in the room to respond to the alarm or ask for help as soon as possible, thus effectively protecting the safety of life and property. This kind of alarm module has been applied in the technology that requires door resistance.

In another embodiment, the present invention provides a room door blocking method, comprising providing apparatus is provided, which includes a stopper 4 for attaching to an inner side of a door, a base 2 laid flatwise on the ground, and a supporting post 3 rotatably connected between the stopper 4 and the base 2, wherein a locking hook component is built in the stopper 4, and the stopper 4 can always cling to a set position on the inner side of the door through a locking action of the locking hook component, so that the installation of the safety door stopper is realized;
the method includes the following steps:
placing the base 2 on the ground behind the door according to the scene; installing different types of anti-skid bottom mats 1 under the base 2, so that the anti-skid bottom mats 1 can be used with different patterns or different materials for different floor surfaces without falling off during use, so as to provide additional resistance to the force applied to the stopper 4;
rotating the supporting post 3 to attach the stopper 4 to the back of the door, and the locking hook component extending into the gap between the door and the ground; the outer end of the movable locking hook 8 of the locking hook component being bent to form a first folded edge 81, the inner end of the movable locking hook 8 being in transmission connection with the adjusting screw 5, the movable locking hook 8 sliding in the stopper 4 through the adjusting screw 5, and its height position being adjusted according to the space under the door to clamp the door bottom, and the distance between the base 2 and the door and the angle between the base 2 and the stopper 4 being not affected during adjustment.

By adjusting the locking hook component, the stopper 4 can always cling to the set position on the inner side of the door, the supporting post 3 only rotates on one plane, and the stopper, the supporting post and the base can rotate like movable joints, without setting rotating parts such as rotating shafts and bearings, which simplifies the structure and keeps the triangular support structure in one plane, which is very stable.

An alarm module is built in the base 2, so that the portable safety door has the function of alarm and reminder; the alarm module can be realized by means of pressure-sensitive trigger, and its selection can be realized by various existing alarm modules with pressure-sensitive trigger in the market. The control circuit of this kind of alarm module can control the buzzer to give an alarm sound, so as to warn people in the room to respond to the alarm or ask for help as soon as possible, thus effectively protecting the safety of life and property. This kind of alarm module has been applied in the technology that requires door resistance.

The portable safety door stopper has the advantages of very small size, convenient storage and carrying, low manufacturing cost, stable support, simple operation, etc. It is suitable for all types of doors and has good universality. The alarm module can be built in the base, so that it also has the alarm reminding function.

In specific use, in order to facilitate the understanding of the present invention, it is described with the attached drawings;

the stopper 4, the supporting post 3 and the base 2 can rotate like movable joints, and are adjusted to an appropriate angle according to the actual scene, so that the stopper 4 abuts against the back of the door, and the base 2 is placed on the ground; at the same time, the first folded edge 81 extends into the gap between the door and the ground, and the adjusting screw 5 is rotated, so that the riveting nut 7 moves upward and drives the movable locking hook 8 to move upward synchronously; the first folded edge 81 abuts against the lower edge of the door to achieve locking, that is, the installation of the portable safety door stopper is completed; when disassembling, it only needs to turn the adjusting nut 5 in the opposite direction

The technical means disclosed in the solution of the present invention are not limited to the technical means disclosed in the above embodiments, but also include the technical solution composed of any combination of the above technical features. It should be pointed out that for those skilled in the art, several improvements and embellishments can be made without departing from the principle of the present invention, and these improvements and embellishments are also regarded as the protection scope of the present invention.

What is claimed is:

1. A portable safety door stopper, comprising a stopper (4) for attaching to an inner side of a door, a base (2) laid flatwise on the ground, and a supporting post (3) rotatably connected between the stopper (4) and the base (2), wherein a locking hook component is built in the stopper (4), and the stopper (4) can always cling to a set position on the inner side of the door through a locking action of the locking hook component, so that the installation of the safety door stopper is realized.

2. The portable safety door stopper according to claim 1, wherein the stopper (4) is formed by fixedly connecting two half shells through screws, and the locking hook component comprises a movable locking hook (8) built in the stopper (4) and an adjusting screw (5) for driving the movable locking hook (8) to slide; and
an outer end of the movable locking hook (8) is bent to form a first folded edge (81), and an inner end of the movable locking hook (8) is in transmission connection with the adjusting screw (5).

3. The portable safety door stopper according to claim 2, wherein the inner end of the movable locking hook (8) is bent to form a second folded edge (82), a through hole is processed on the second folded edge (82) and a riveting nut (7) is arranged at the position of the through hole; and
the adjusting screw (5) is in threaded connection with the riveting nut (7), and the adjusting screw (5) is provided with two shaft clamps (6) to limit an axial movement thereof.

4. The portable safety door stopper according to claim 1, wherein both ends of the supporting post (3) are ball heads (31), and both sides of each of the ball heads (31) are provided with flat cutting parts (311); and
the base (2) and the stopper (4) are both provided with cavities matched with the ball heads (31) after cutting.

5. The portable safety door stopper according to claim 1, wherein a bottom of the base (2) is provided with a non-slip bottom mat (1).

6. The portable safety door stopper according to claim 1, wherein an alarm module is built in the base (2).

7. The portable safety door stopper according to claim 2, wherein knurling is processed on a top of the first folded edge (81) and a side surface of the stopper (4).

8. The portable safety door stopper according to claim 3, wherein a compression spring is sleeved on the adjusting screw (5), and the compression spring is elastically supported between the second folded edge (82) and the inner wall of the stopper (4).

9. A portable safety door stopper, comprising a stopper (4) for attaching to an inner side of a door, a base (2) laid flatwise on the ground, and a supporting post (3) rotatably connected between the stopper (4) and the base (2) to swing in a limited range, wherein the stopper (4) is internally provided with a retractable insert part inserted into a gap at the bottom of the door, and an adjusting part for adjusting an extension length of the insert part is arranged in the stopper.

10. The portable safety door stopper according to claim 9, wherein the stopper (4) is formed by fixedly connecting two half shells through screws; and
the insert part comprises a movable locking hook (8) built in the stopper (4), and the adjusting part comprises an adjusting screw (5) for driving the movable locking hook (8) to slide; and
an outer end of the movable locking hook (8) is bent to form a first folded edge (81), and an inner end of the movable locking hook (8) is in transmission connection with the adjusting screw (5).

11. The portable safety door stopper according to claim 10, wherein the inner end of the movable locking hook (8) is bent to form a second folded edge (82), a through hole is processed on the second folded edge (82) and a riveting nut (7) is arranged at the position of the through hole; and
the adjusting screw (5) is in threaded connection with the riveting nut (7), and the adjusting screw (5) is provided with two shaft clamps (6) to limit an axial movement thereof.

12. The portable safety door stopper according to claim 11, wherein a compression spring is sleeved on the adjusting screw (5), and the compression spring is elastically supported between the second folded edge (82) and the inner wall of the stopper (4).

13. The portable safety door stopper according to claim 10, wherein knurling is processed on a top of the first folded edge (81) and a side surface of the stopper (4).

14. The portable safety door stopper according to claim 9, wherein both ends of the supporting post (3) are ball heads (31), and both sides of each of the ball heads (31) are provided with flat cutting parts (311); and
the base (2) and the stopper (4) are both provided with cavities matched with the ball heads (31) after cutting.

15. The portable safety door stopper according to claim 9, wherein a bottom of the base (2) is provided with a non-slip bottom mat (1).

16. The portable safety door stopper according to claim 9, wherein an alarm module is built in the base (2).

17. A room door blocking method, comprising
providing an apparatus, which comprises a stopper (4) for attaching to an inner side of a door, a base (2) laid flatwise on the ground, and a supporting post (3) rotatably connected between the stopper (4) and the base (2), wherein a locking hook component is built in the stopper (4), and the stopper (4) can always cling to a set position on the inner side of the door through a locking action of the locking hook component, so that the installation of the safety door stopper is realized;
the method comprises the following steps:
placing the base (2) on the ground behind the door according to a scene;
rotating the supporting post (3) to attach the stopper (4) to the back of the door, and the locking hook component extending into the gap between the door and the ground; and
adjusting the locking hook component so that the stopper (4) can always cling to the set position on the inner side of the door through a locking action.
